(19) United States
(12) Patent Application Publication
(10) Pub. No.: US 2017/0361450 A1
(43) Pub. Date: Dec. 21, 2017

(54) QUICKLY ROTARY AND EXPANDABLE RATCHET WRENCH

(71) Applicant: YIH CHENG FACTORY CO., LTD., Nantuo (TW)

(72) Inventor: Chih-Hung CHIEN, Nantuo (TW)

(21) Appl. No.: 15/185,079

(22) Filed: Jun. 17, 2016

(51) Int. Cl. B25G 1/04; B25B 23/00; B25B 13/46

(52) U.S. Cl. CPC B25G 1/043; B25B 13/461; B25B 23/0028

(57) ABSTRACT

A quickly rotary and expandable ratchet wrench includes a drive bar, an operation handle, a rotary head, and an operation ring. The drive bar includes a bar body and a fork arm connected to the bar body. The bar body includes a plurality of retaining recesses spaced apart from each other and a groove passing through each of the retaining recesses. The operation handle includes a retaining element slidable to position in any of the retaining recesses and a restraint element protruding into the groove. The rotary head is pivotally connected to two ends of the fork arm. The operation ring sleeves on one end of the operation handle, and the retaining element is movable in association with movement of the operation ring to be positioned in any of the retaining recesses, and the operation ring is rotatable with respect to the drive bar.

### TECHNICAL FIELD

The present invention relates to a ratchet wrench and, in particular, to a quickly rotary and expandable ratchet wrench.

### BACKGROUND

Wrenches are commonly used tools. In conventional wrenches, operation method includes moving a head portion horizontally or rotating a ratchet back and forth. There are various nuts and bolts in different sizes provided to adapt to different purposes and requirements, and even in the same machine there may also be various nuts and bolts in different sizes. As a result, it is required to prepare a large number of wrenches to adapt to various sizes of nuts and bolts for loosening or tightening operations. However, it is costly to buy many wrenches and it is also complicated and inconvenience to store and manage them.

Moreover, the conventional wrench is normally provided with a short handle, a middle handle, a long handle, or etc. To have wrenches of multiple lengths is not only costly but also inconvenience since storing them requires a large storage space.

Accordingly, the inventor made a lot of studies to solve the above-mentioned problems, on the basis of which the present invention is accomplished.

### SUMMARY

It is an object of the present invention to provide a quickly rotary and expandable ratchet wrench, whereby a user can hold an operation ring to expand or shorten an operation handle and can rotate an object quickly.

Accordingly, the present invention provides a quickly rotary and expandable ratchet wrench, comprising a drive bar, an operation handle, a rotary head, and an operation ring. The drive bar includes a bar body and a fork arm connected to the bar body. The bar body includes a plurality of retaining recesses spaced apart from each other and a groove passing through each of the retaining recesses. The operation handle includes a retaining element slidable to position in any of the retaining recesses, a restraint element protruding into the groove, and a cavity accommodating the bar body. The rotary head includes a round housing and a ratchet apparatus disposed in the round housing, and the rotary head is pivotally connected to two ends of the fork arm. The operation ring sleeves on one end of the operation handle, wherein the retaining element is movable in association with movement of the operation ring to be positioned in any of the retaining recesses, and the operation ring is rotatable with respect to the drive bar.

The present invention further has the following merits. The retaining element of the operation handle is protrudingly disposed to be engaged with the groove of the bar body, and the retaining element is positioned in a corresponding retaining recess, so that no matter which retaining recess the operation ring is fastened to, the operation handle can rotate quickly. Moreover, the present invention further includes a locking button disposed in an axial hole. The locking button can keep engaged with a fastening recess of the rotary head, so as to achieve safety and stability during operation.

### BRIEF DESCRIPTION OF THE DRAWINGS

The disclosure will become more fully understood from the detailed description, and the drawings given herein below is for illustration only, and thus does not limit the disclosure, wherein:

FIG. 1 is a perspective view illustrating the present invention according to a first preferable embodiment;

FIG. 2 is a cross-sectional view illustrating the present invention according to the first preferable embodiment;

FIG. 3 is another cross-sectional view illustrating the present invention according to the first preferable embodiment;

FIG. 4 is another perspective view illustrating the present invention according to a first preferable embodiment;

FIG. 5 is a cross-sectional view of FIG. 4;

FIG. 6 is a perspective view illustrating the present invention according to a second preferable embodiment; and

FIG. 7 is a cross-sectional view illustrating the present invention according to the second preferable embodiment.

### DETAILED DESCRIPTION

Detailed descriptions and technical contents of the present invention are illustrated below in conjunction with the accompany drawings. However, it is to be understood that the descriptions and the accompany drawings disclosed herein are merely illustrative and exemplary and not intended to limit the scope of the present invention.

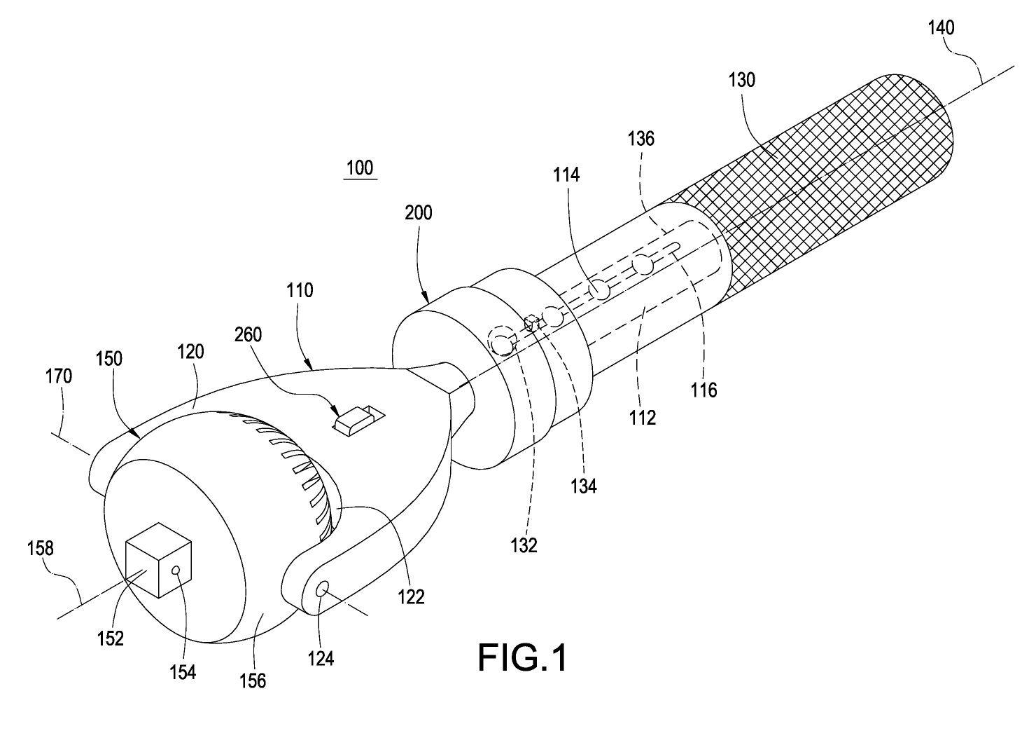

Referring to FIGS. 1 to 5, the present invention provides a quickly rotary and expandable ratchet wrench 100, comprising a drive bar 110, an operation handle 130, a rotary head 150, and an operation ring 200. The drive bar 110 includes a bar body 112 and a fork arm 120 connected to the bar body 112. The bar body 112 includes a plurality of retaining recesses 114 spaced apart from each other and a groove 116 passing through each of the retaining recesses 114. A depth of each of the retaining recesses 114 is greater than a depth of the groove 116. The operation handle 130 includes a retaining element 132 slidable to position in any of the retaining recesses 114, a restraint element 134 protruding into the groove 116, and a cavity 136 accommodating the bar body 112.

The rotary head 150 is pivotally connected to two ends of the fork arm 120. In the present embodiment, the rotary head 150 includes a round housing 156, a ratchet apparatus (not illustrated) disposed inside the round housing 156, an output element 152 of rectangular shape protrudingly disposed at one end of the round housing 156, a plurality of fastening recesses 160 externally disposed on the round housing 156, a positioning ball 154 at one side surface of the output element 152, and a ratchet apparatus (not illustrated) connected to the output element 152. The output element 152 can be in various sizes, e.g. ¼ inch, ⅜ inch, or ½ inch; however, the present invention is not limited in this regard. The rotary head 150 can be engagedly assembled with a variety of sleeves (not illustrated) in different sizes by means of the positioning ball 154 of the output element 152, so as to tighten or loosen the object (not illustrated). The ratchet apparatus is a conventional apparatus, so a detailed description thereof is omitted for brevity.

In addition, the drive bar 110 further includes two supporting bolts 124 and a pivot axis 170 passing through two ends of the fork arm 120. The two supporting bolts 124 are installed at the two ends of the fork arm 120 and pivotally connected between the round housing 210 and the fork arm 120, so that the rotary head 200 is freely rotatable about the pivot axis 170 at the fork opening 122 to certain angles, e.g. from 0 to 270 degrees.

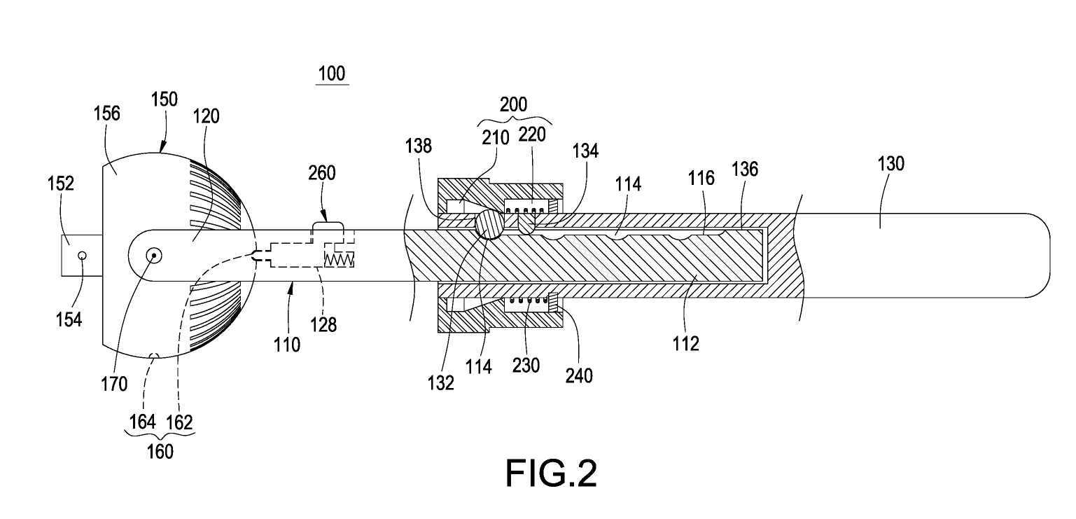

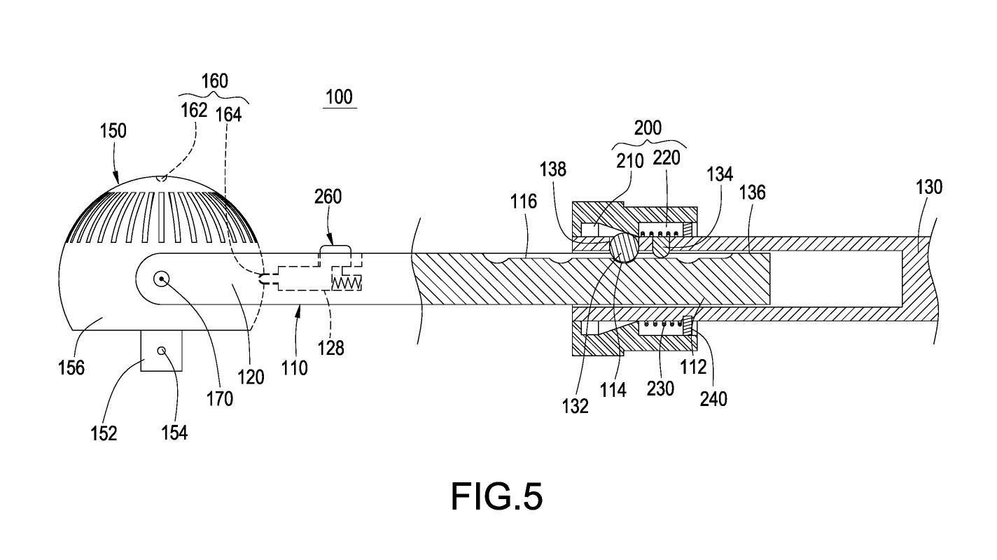

In the embodiment shown in FIGS. 2 and 5, the fastening recesses 160 at least include a first fastening recess 162 disposed on a top of the round housing 156 and a second fastening recess 164 disposed at each of two opposite sides of the round housing 156. The first fastening recess 162 and the second fastening recess 164 form an included angle of 90 degrees therebetween, so that a user can quickly rotate the ratchet wrench 100 in an upright state thereof or swing the operation handle 130 in a horizontal state thereof, so that the rotary head 200 can tighten or loosen an object (not illustrated).

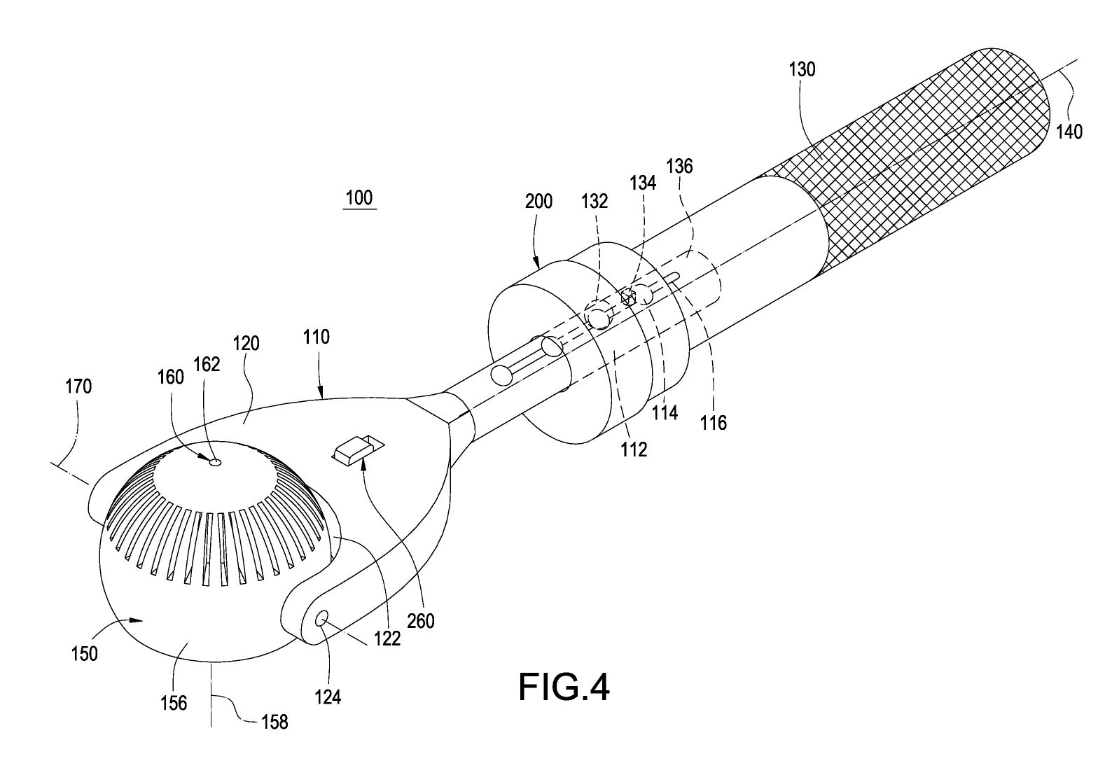

In other words, when a central axis 158 of the output element 152 is parallel to a rotation axis 140 of the drive bar 110, one hand of the user can hold the operation ring 200 in its upright state, and the other hand can quickly rotate the operation handle 130 to tighten or loosen the object. However, in the embodiment shown in FIGS. 4 and 5, when the central axis 158 of the output element 152 is perpendicular to the rotation axis 140 of the drive bar 110, the user can move the ratchet wrench 100 back and forth in its horizontal state. The rotation axis 140 herein is preferably a central line of the drive bar 110 and/or the operation handle 130.

The operation ring 200 sleeves on one end of the operation handle 130. The retaining element 132 is movable in association with movement of the operation ring 200 to be positioned in any of the retaining recesses 114, and the operation ring 200 is rotatable with respect to the drive bar 110. In the embodiment shown in FIGS. 2, 3 and 5, the operation ring 200 further includes a first indentation 210 and a second indentation 220 disposed corresponding to the first indentation 210. The first indentation 210 and the second indentation 220 are respectively formed on the inner surface at two ends of the operation ring 200, and the retaining element 132 is disposed in the first indentation 210.

The operation handle 130 includes a through hole 138 receiving the retaining element 132, a fastener 240 disposed in the second indentation 220, and a flexible element 230 in contact with the fastener 240 at one side thereof. The through hole 138 is in communication with the first indentation 210, so the retaining element 132 is movable in the through hole 138 along the groove 116 of the bar body 112. The flexible element 230 is disposed corresponding to the second indentation 220 and encloses an outer circumferential surface of the operation handle 130. The fastener 240 herein is preferably a C-shaped fastener or other suitable fastening element. The operation ring 200 includes an inclined surface 212 in the first indentation 210, and the retaining element 132 is slidable along the inclined surface 212 to be positioned in any of the retaining recesses 114. In the present embodiment, the retaining element 132 is preferably a spherical rolling ball, an arc-shaped rolling ball, or other suitable elements. The flexible element 230 is a compression spring or other suitable element.

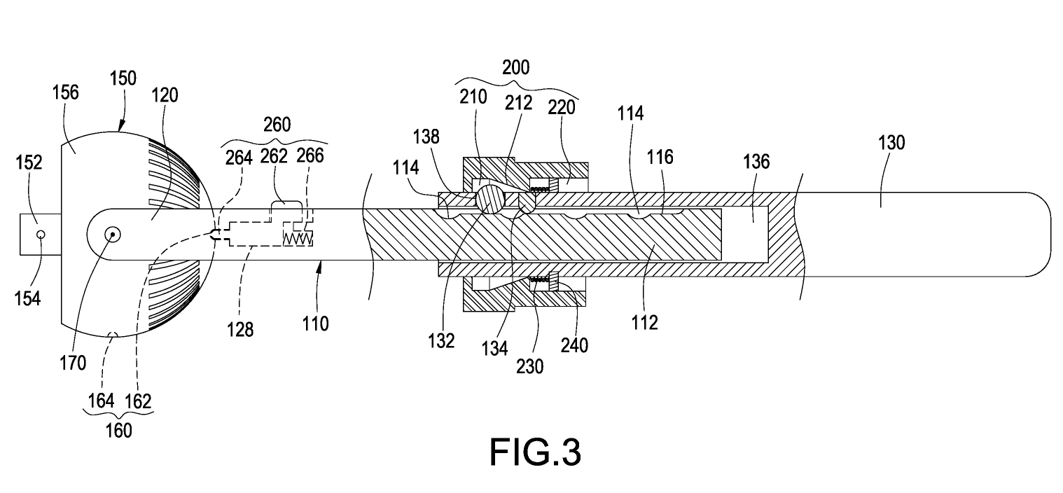

How to operate the quickly rotary and expandable ratchet wrench 100 is more full detailed as follows. Referring to FIGS. 1 and 2, when the operation handle 130 does not expand, the retaining element 132 is compressed and positioned in the retaining recess 114 in the front-most end of the bar body 112. As shown in FIG. 3, when the operation handle 130 extend in length, the operation ring 200 moves with respect to the operation handle 130 toward a bottom of the cavity 136. The flexible element 230 is compressed, and the restraint element 134 of the operation ring 200 moves along the groove 116 of the bar body 112.

That is to say, the operation ring 200 drives the retaining element 132 and the operation handle 130 to axially move at the same time on the bar body 112, and the operation ring 200 is released when the operation handle 130 is adjusted to a suitable length. At this point, the flexible element 230 recoils to position the retaining element 132 in a corresponding retaining recess 114 by means of the inclined surface 212. On the contrary, when it is desired to shorten a length of the operation handle 130, this can be done by moving the operation ring 200 to be close to the rotary head 150, and then releasing the operation ring 200 when the operation handle 130 is adjusted to a desired length, and thus operations can be done with ease. Therefore, no matter whether it is required to expand or shorten the operation handle 130, the user has to push the operation ring 200 backwards, so that the retaining element 132 of the operation ring 200 can be released and moved to a suitable one of the retaining recesses 114 of the bar body 112.

In particular, when the operation needs quick rotations, the restraint element 134 of the operation handle 130 is protrudingly disposed to be engaged with the groove 116 of the bar body 112 to restrain movement with respect each other, and the retaining element 132 is positioned in a corresponding one of the retaining recesses 114, and therefore no matter which retaining recess 114 the operation ring 200 is fastened to, the operation handle 130 can rotate quickly without sliding away.

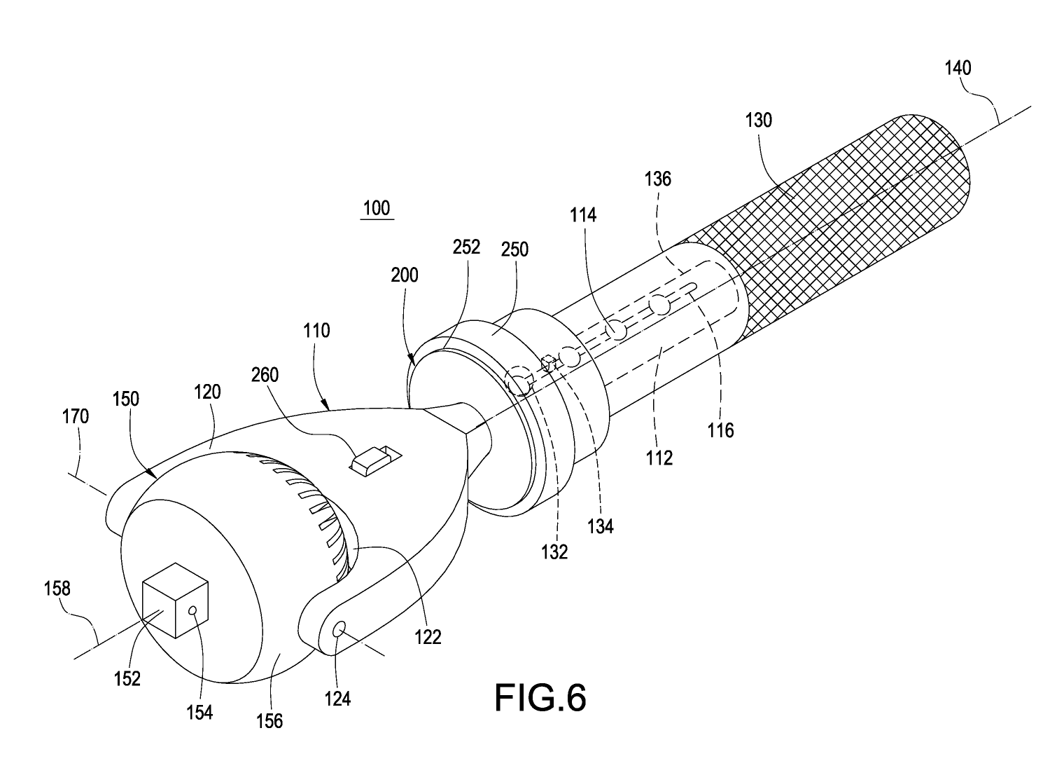

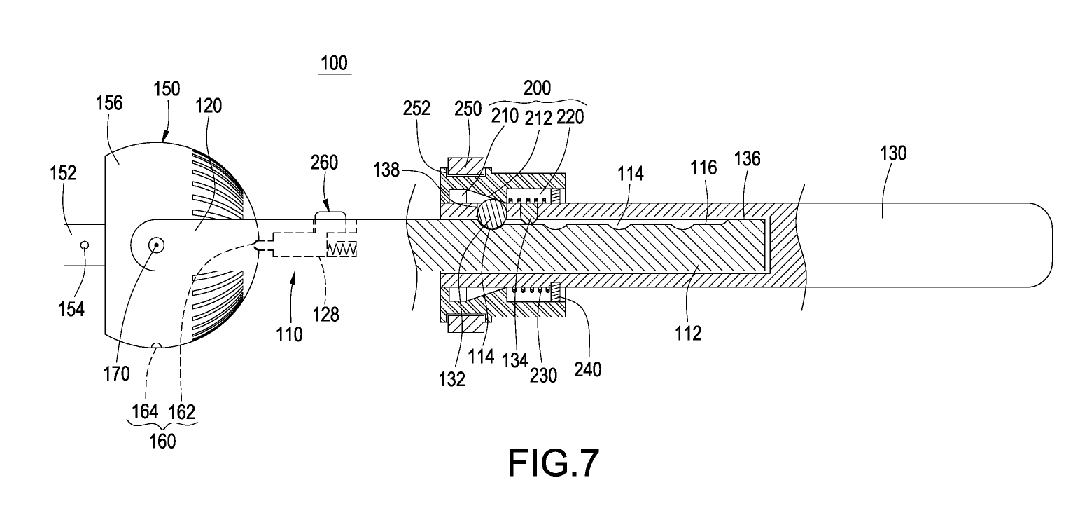

Please refer to FIGS. 6 and 7 which are a perspective view and a cross-sectional view according to a second preferable embodiment of the present invention. As shown in the drawings, the operation ring 200 of the present embodiment includes an annular groove 252 and a rotary ring 250 disposed at the annular groove 252. The rotary ring 250 is rotatable with respect to the operation ring 200 and the operation handle 130, so that one hand of the user can hold the rotary ring 250, and the other hand can quickly rotate the operation handle 130 to tighten or loosen the object (not illustrated).

Furthermore, the present embodiment further includes a locking button 260 for fastening the rotary head 150. In addition, referring to FIG. 3, the locking button 260 is preferably disposed in the drive bar 110 having an axial hole 128. The locking button 260 includes a slide button 262, a fixing pin 264 connected to one end of the slide button 262, and a locking spring 266 connected to the other end of the slide button 262. One end of the slide button 262 preferably protrudes out of the axial hole 128 of the drive bar 110 so as to facilitate the user's operations. The fixing pin 264 preferably has a shape corresponding to the shape of the fastening recess 160, e.g. a semi-circular shape, an arc shape, or other suitable shape, so that the fixing pin 264 can be engaged with the fastening recess 160 easily.

The fixing pin 264 protrudes outwardly into the fork opening 122 under the action of the locking spring 266 and keeps engaged with any fastening recess 160 (the first fastening recess 162 in this embodiment). The user just needs to move or push the locking button 260 to disengage the fixing pin 264 from the first fastening recess 162, and then the rotary head 150 can rotate to a desired angle as required, e.g. to the second fastening recess 164. After the locking button 260 is released, the locking spring 266 recoils to enable engagement with the second fastening recess 164, so that the rotary head 150 can be secured, as shown in FIGS. 5 and 6.

It should be noted that, a size of the fork arm 120 of the drive bar 110 is usually greater than a size of the bar body 142, so that the ratchet wrench 100 has better strength and provides superior operation quality. Furthermore, in order to allow the user to firmly and stably hold the operation ring 200 and/or the operation handle 130, the operation ring 200 and/or the operation handle 130 further includes a knurl structure on its partial surface or its outer surface.

Therefore, in the present embodiment, the operation handle 130 of the ratchet wrench 100 can be expanded or shortened with ease at any time to adapt to the work environment. In addition to that, the operation handle 130 can be rotated quickly when the ratchet wrench 100 is in the upright state, i.e. the central axis 158 of the output element 152 is parallel to the rotation axis 140 of the drive bar 110, so as to quickly tighten or loosen the object (not illustrated).

It is to be understood that the above descriptions are merely the preferable embodiments of the present invention and are not intended to limit the scope of the present invention. Equivalent changes and modifications made in the spirit of the present invention are regarded as falling within the scope of the present invention.

What is claimed is:

1. A quickly rotary and expandable ratchet wrench, comprising:
a drive bar, the drive bar including a bar body and a fork arm connected to the bar body, the bar body including a plurality of retaining recesses spaced apart from each other and a groove passing through each of the retaining recesses;
an operation handle, the operation handle including a retaining element slidable to position in any of the retaining recesses, a restraint element protruding into the groove, and a cavity accommodating the bar body;
a rotary head, the rotary head including a round housing and a ratchet apparatus disposed inside the round housing, the rotary head being pivotally connected to two ends of the fork arm; and
an operation ring, the operation ring receiving one end of the operation handle, wherein the retaining element is movable in association with movement of the operation ring to be positioned in any of the retaining recesses, and the operation ring is rotatable with respect to the drive bar.

2. The quickly rotary and expandable ratchet wrench of claim 1, wherein the operation ring includes a first indentation and a second indentation disposed corresponding to the first indentation.

3. The quickly rotary and expandable ratchet wrench of claim 2, wherein the first indentation and the second indentation are respectively formed at two ends of the operation ring, and the retaining element is disposed in the first indentation.

4. The quickly rotary and expandable ratchet wrench of claim 2, wherein the operation handle further includes a through hole receiving the retaining element, a fastener disposed in the second indentation, and a flexible element in contact with the fastener at one side thereof.

5. The quickly rotary and expandable ratchet wrench of claim 4, wherein the through hole is in communication with the first indentation, and the flexible element is disposed corresponding to the second indentation and encloses an outer circumferential surface of the operation handle.

6. The quickly rotary and expandable ratchet wrench of claim 4, wherein the operation ring includes an inclined surface in the first indentation, and the retaining element is slidable along the inclined surface to be positioned in any of the retaining recesses.

7. The quickly rotary and expandable ratchet wrench of claim 4, wherein the retaining element is a spherical rolling ball or an arc-shaped rolling ball, and the flexible element is a compression spring.

8. The quickly rotary and expandable ratchet wrench of claim 1, wherein the operation ring includes an annular groove and a rotary ring disposed at the annular groove, and the rotary ring is rotatable with respect to the operation ring and the operation handle.

9. The quickly rotary and expandable ratchet wrench of claim 1, wherein the rotary head includes a pivot axis passing through the two ends of the fork arm, and the rotary head is rotatable by an angle about the pivot axis.

10. The quickly rotary and expandable ratchet wrench of claim 1, further comprising a locking button, the locking button being disposed in the drive bar having an axial hole.

11. The quickly rotary and expandable ratchet wrench of claim 10, wherein the rotary head further includes an output element protrudingly disposed at one end of the round housing, and a plurality of fastening recesses externally disposed on the round housing, and the locking button is flexibly movable to be engaged with any of the fastening recesses.
